(19) United States
(12) Patent Application Publication
(10) Pub. No.: US 2026/0219652 A1
(43) Pub. Date: Jul. 30, 2026

(54) INFORMATION PROCESSING DEVICE AND INFORMATION PROCESSING METHOD

(71) Applicant: SINTOKOGIO, LTD., Nagoya-Shi (JP)

(72) Inventor: Tomo Nishigaki, Nagoya-Shi (JP)

(73) Assignee: SINTOKOGIO, LTD., Nagoya-Shi (JP)

(21) Appl. No.: 19/455,090

(22) Filed: Jan. 21, 2026

(30) Foreign Application Priority Data
Jan. 31, 2025 (JP) 2025-014821

(51) Int. Cl. G05B 19/418

(52) U.S. Cl. CPC G05B 19/4184; G05B 19/4185

(57) ABSTRACT

An information processing device is connected to pieces of equipment and connected to a communication server and configured to transmit and receive data with the communication server. The pieces of equipment include machines as operation targets, sensors provided in the machines, and control devices that operate the machines. The information processing device includes a transmission unit that transmits, to the communication server, notification data for providing notification of information related to the machines on the basis of sensor information by the sensors, a reception unit that acquires, from the communication server, response data in response to the notification data, and a control unit that outputs, to the control devices, a control instruction including operation content of the machines in accordance with the response data.

### TECHNICAL FIELD

The present disclosure relates to an information processing device and an information processing method.

### BACKGROUND ART

Information processing devices that output a state of equipment have been proposed. For example, Patent Literature 1 describes an information processing device that receives information indicating a state of equipment in a manufacturing facility and outputs an alarm indicating occurrence of an abnormality or a sign of an abnormality in the equipment on the basis of the information.

### CITATION LIST

### Patent Literature

Patent Literature 1: JP 7459872 A

### SUMMARY OF INVENTION

### Technical Problem

A worker who confirms the information of the equipment needs to go to the equipment to operate the equipment. Therefore, easy operation of the equipment is required.

An object of the present disclosure is to provide an information processing device and an information processing method that can easily operate equipment.

### Solution to Problem

An information processing device according to the present disclosure is an information processing device connected to equipment and connected to a communication server and configured to transmit and receive data with the communication server. The equipment includes an operation target, a sensor provided in the operation target, and a control device that operates the operation target. The information processing device includes a transmission unit that transmits, to the communication server, notification data for providing notification of information related to the operation target on the basis of sensor information by the sensor, a reception unit that acquires, from the communication server, response data in response to the notification data, and a control unit that outputs, to the control device, a control instruction including operation content of the operation target in accordance with the response data.

An information processing method according to the present disclosure is an information processing method executed by an information processing device connected to equipment and connected to a communication server and configured to transmit and receive data with the communication server. The equipment includes an operation target, a sensor provided in the operation target, and a control device that operates the operation target. Processing executed by the information processing device includes transmitting, to the communication server, notification data for providing notification of information related to the operation target on the basis of sensor information by the sensor, acquiring, from the communication server, response data in response to the notification data, and outputting, to the control device, a control instruction including operation content of the operation target in accordance with the response data.

### Advantageous Effects of Invention

According to an information processing device and an information processing method of the present disclosure, equipment can be easily operated.

### BRIEF DESCRIPTION OF DRAWINGS

FIG. 1 is a schematic configuration view of an information processing system of a first embodiment.

FIG. 2 is a schematic configuration view illustrating an example of a configuration of an information processing device in FIG. 1.

FIG. 3 is an explanatory view illustrating an example of registered words of the information processing device in FIG. 1.

FIG. 4 is an explanatory view illustrating a configuration example of scenarios of the information processing device in FIG. 1.

FIG. 5 is an explanatory view illustrating an example of a scenario of the information processing device in FIG. 1.

FIG. 6 is an explanatory view illustrating an example of notification messages in the scenario in FIG. 4.

FIG. 7 is an explanatory view illustrating an example of response messages in the scenario in FIG. 4.

FIG. 8 is a flowchart illustrating an outline of processing of the information processing device in FIG. 1.

FIG. 9 is an explanatory view illustrating a scenario of a modification example.

FIG. 10 is a flowchart illustrating an outline of processing of the modification example.

FIG. 11 is a schematic configuration view of an information processing system of a second embodiment.

FIG. 12 is an explanatory view illustrating an example of registered words of the information processing device in FIG. 11.

FIG. 13 is an explanatory view illustrating an example of a scenario of the information processing device in FIG. 11.

FIG. 14 is a flowchart illustrating an outline of processing of the information processing device of FIG. 11.

### DESCRIPTION OF EMBODIMENTS

Hereinafter, embodiments and modification examples will be described with reference to the drawings.

The terms “first”, “second”, “third”, and the like in the present disclosure are used merely to distinguish objects, and are not intended to rank the objects.

### First Embodiment

Hereinafter, an information processing system 10 of a first embodiment will be described.

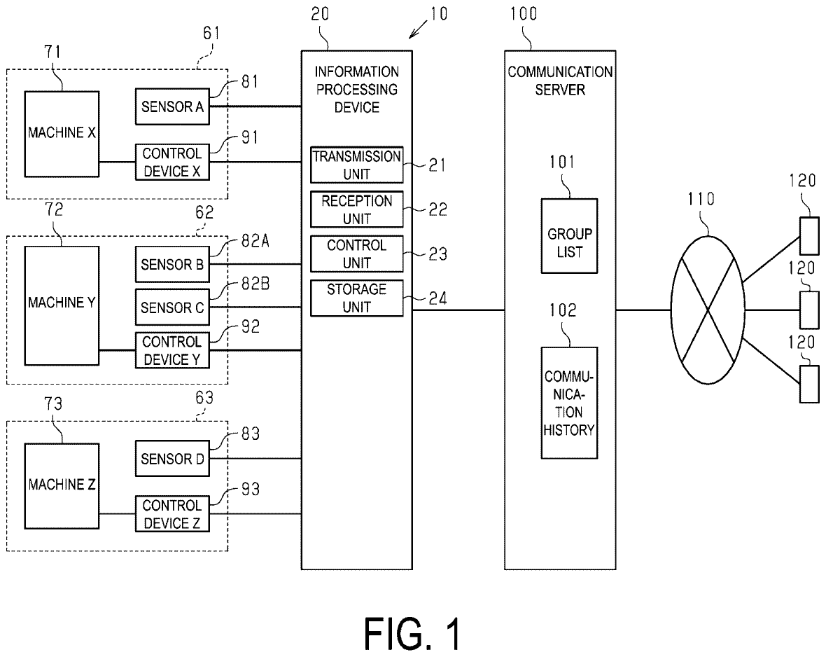

As illustrated in FIG. 1, the information processing system 10 includes an information processing device 20 connected to a plurality of pieces of equipment 61, 62, and 63. The information processing system 10 may be configured to include at least one piece of equipment.

The plurality of pieces of equipment 61, 62, and 63 are, in one example, equipment related to manufacturing and disposed in a manufacturing facility.

The plurality of pieces of equipment 61, 62, and 63 constitute a manufacturing line, in one example. Note that two of the plurality of pieces of equipment 61, 62, and 63 may constitute a manufacturing line, or each of the plurality of pieces of equipment 61, 62, and 63 may constitute a manufacturing line. Further, the plurality of pieces of equipment 61, 62, and 63 may be devices that perform the same processing or may be devices that perform different processing.

The equipment 61 includes a machine 71 as an operation target, a sensor 81 provided in the machine 71, and a control device 91 that controls the machine 71. The equipment 62 includes a machine 72 as an operation target, sensors 82A and 82B provided in the machine 72, and a control device 92 that controls the machine 72. The equipment 63 includes a machine 73 as an operation target, a sensor 83 provided in the machine 73, and a control device 93 that controls the machine 73. That is, the equipment includes a machine related to manufacturing and a control device that controls the sensor and device provided in the machine.

FIG. 1 indicates names for distinguishing the machines 71, 72, and 73, the sensors 81, 82A, 82B, and 83, and the control device 91, 92, and 93 of the pieces of equipment 61, 62, and 63 by the information processing device 20. In the example illustrated in FIG. 1, the machines 71, 72, and 73 are indicated as “machine X”, “machine Y”, and “machine Z”, respectively. In the information processing device 20, the character strings indicated in FIG. 1 are registered, and the machines 71, 72, and 73 are handled in a distinguishable manner. Further, in FIG. 1, the sensors 81, 82A, 82B, and 83 are indicated as “sensor A”, “sensor B”, “sensor C”, and “sensor D”, respectively, and the control devices 91, 92, and 93 are indicated as “control device X”, “control device Y”, and “control device Z”, respectively. In the information processing device 20, the character strings indicated in FIG. 1 are registered, and the sensors 81, 82A, 82B, and 83 and the control devices 91, 92, and 93 are handled in a distinguishable manner.

The sensor 81 of the equipment 61 is, in one example, a sensor that detects a temperature of the machine 71. The sensor 81 is configured to detect the temperature of the machine 71 in a contact or non-contact manner. Note that the sensor 81 may detect a temperature around the machine 71 as the temperature of the machine 71. The control device 91 of the equipment 61 controls, in one example, stoppage of the machine 71. The sensor 82A of the equipment 62 is, in one example, a sensor that detects a temperature of the machine 72. The sensor 82A is configured to detect the temperature of the machine 72 in a contact or non-contact manner. Note that the sensor 82A may detect a temperature around the machine 72 as the temperature of the machine 72. The sensor 82B of the equipment 62 is, in one example, a sensor that detects a current related to an output of the machine 72. The control device 92 of the equipment 62 controls, in one example, an operating state and stoppage of the machine 72. Further, the control device 92 controls, in one example, the output of the machine 72. The output of the machine 72 is detected by, for example, a current value. The sensor 83 of the equipment 63 is, in one example, a sensor that detects a rotation speed related to operation of the machine 73. The control device 93 of the equipment 63 controls, in one example, rotation of the machine 73.

Note that the sensors 81, 82A, 82B, and 83 are examples of sensors that detect the machines 71, 72, and 73, and other sensors such as, for example, a sensor that detects pressure, a sensor that detects voltage, and a sensor that detects vibration may be provided in accordance with the machine.

The information processing device 20 is connected to the pieces of equipment 61, 62, and 63. Specifically, the information processing device 20 is thus connected so as to enable acquisition of sensor information from the sensors 81, 82A, 82B, and 83 of the pieces of equipment 61, 62, and 63. The sensor information includes measured values obtained by detecting states of the machines 71, 72, and 73 by the sensors 81, 82A, 82B, and 83. Further, the information processing device 20 is thus connected so as to enable transmission and reception with the control devices 91, 92, and 93 of the pieces of equipment 61, 62, and 63.

In FIG. 1, the information processing device 20 is individually connected to the pieces of equipment 61, 62, and 63. The information processing device 20 and the pieces of equipment 61, 62, and 63 may be connected by a network such as a local area network directly or indirectly using a gateway or the like. Further, the information processing device 20 and the pieces of equipment 61, 62, and 63 may be connected by a wired communication path or a wireless communication path.

The information processing device 20 is configured to be capable of communicating with a communication server 100. The information processing device 20 is connected to the communication server 100 so as to enable data transmission and reception therewith. The information processing device 20 and the communication server 100 may be connected by a network such as a local area network directly or indirectly using a gateway or the like. Further, the information processing device 20 and the communication server 100 may be connected to each other by a wired communication path or a wireless communication path.

The communication server 100 is communicably connected to at least one communication terminal 120 by a communication path 110. The communication path 110 includes the Internet and a public telephone network. In FIG. 1, three communication terminals 120 are illustrated. The three communication terminals 120 are terminals set as a communication group in the communication server 100. The communication group includes the communication terminals 120 and the information processing device 20 illustrated in FIG. 1. A communication terminal that is not set as the communication group, or a communication terminal that is set in a communication group different from that of the communication terminals 120 illustrated in FIG. 1 may be connected to the communication server 100.

The communication server 100 includes a group list 101 in which a communication group including at least one communication terminal 120 is set. The communication server 100 is configured to be capable of data transmission and reception with the communication terminal 120 included in the group list 101. The communication terminal 120 is a terminal carried by a responsible party of the information processing system 10. The responsible party may be, for example, a worker or a manager who operates the pieces of equipment 61, 62, and 63. The communication terminal 120 may be, for example, a mobile phone, a smartphone, a tablet PC, or a predetermined dedicated terminal. Data transmitted and received between the communication server 100 and the communication terminal 120 includes voice data and text data. The voice data and the text data are, in one example, in Japanese. The voice data and the text data may be in any language other than Japanese. The voice data and the text data may be changed in accordance with the communication terminal 120. For example, the voice data and the text data may be in a language according to a setting for each communication terminal. The language of the voice data and the language of the text data may differ from each other. The communication server 100 and the communication terminal 120 are configured to be able to communication with each other by voice data and text data such as email and chat. In one example, the communication server 100 and the communication terminal 120 can communicate with each other by mutually transmitting and receiving packets including voice data and text data.

In one example, the communication server 100 is configured to transmit voice data to the communication terminals 120 included in the group list 101 all at once. In this case, the communication server 100 is communicably connected to the communication terminal 120 by a communication network including a base station for voice communication. Note that the communication server 100 may be configured to transmit voice data, text data, or both voice data and text data to the communication terminals 120 according to settings of the group list 101.

Further, the communication server 100 is configured to store a communication history 102 of the communication group. For the communication with the communication terminals 120 in the communication group, the communication server 100 is configured to convert voice data into text data and store the text data in the communication history 102. In a case in which text data is communicated with the communication terminal 120, the communication server 100 stores the communicated text data in the communication history 102. The communication history 102 is configured as text data.

### Overview of Processing of Information Processing Device

The information processing device 20 has a function of notifying each communication terminal 120 of the states of the machines 71, 72, and 73 of the pieces of equipment 61, 62, and 63 through the communication server 100. Accordingly, the responsible party who carries the communication terminal 120 can easily identify the states of the pieces of equipment 61, 62, and 63 by the notification from the information processing device 20 through the communication server 100.

The information processing device 20 has a function of acquiring information for control from each communication terminal 120 through the communication server 100. The information processing device 20 has a function of outputting control instructions for the machines 71, 72, and 73 of the pieces of equipment 61, 62, and 63 to the control devices 91, 92, and 93 of the pieces of equipment 61, 62, and 63 on the basis of the acquired information for control. The control devices 91, 92, and 93 have functions of controlling the machines 71, 72, and 73 on the basis of the control instructions. Accordingly, even in a case that the responsible party holding the communication terminal 120 is located at a position away from the pieces of equipment 61, 62, and 63, the responsible party can control the machines 71, 72, and 73 of the pieces of equipment 61, 62, and 63 at that location.

Processing functions of the information processing device 20 will be described with reference to FIG. 1.

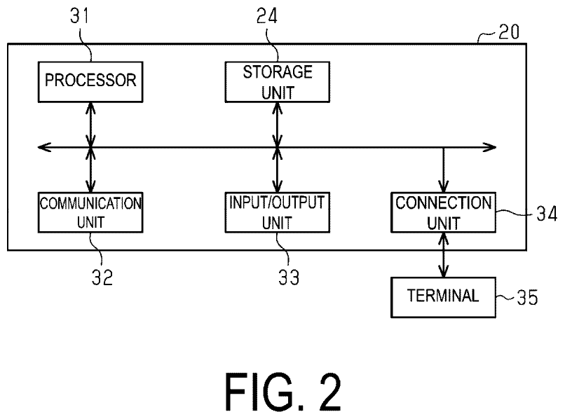

The information processing device 20 includes a transmission unit 21, a reception unit 22, a control unit 23, and a storage unit 24. The transmission unit 21, the reception unit 22, and the control unit 23 may be provided in the information processing device 20 as constituent elements for the respective functions. Further, the transmission unit 21, the reception unit 22, and the control unit 23 may be functions implemented by a processor 31 illustrated in FIG. 2.

The processing functions of the information processing device 20 are similar for the pieces of equipment 61, 62, and 63. Therefore, in the following, the processing for the equipment 61 will be mainly described, and reference will be made to the pieces of equipment 62, 63, as necessary.

The transmission unit 21 transmits notification data for providing notification of information related to the machine 71, serving as an operation target, to the communication server 100 on the basis of the sensor information by the sensor 81. The communication server 100 transmits the notification data to the communication terminals 120 of the communication group. In one example, the communication server 100 converts the notification data into voice data. Then, the communication server 100 transmits the voice data to the communication terminals 120 of the communication group. In one example, the communication server 100 transmits a packet including the voice data to the communication terminals 120 of the communication group. That is, the communication server 100 performs one-to-many group simultaneous voice communication. The communication terminal 120 reproduces the voice data, that is, the notification message received by the communication terminal 120, according to the operation of the responsible party. Thus, the information processing device 20 can notify the responsible party who possesses the communication terminal 120 of the state of the machine 71 of the equipment 61 by using the communication server 100. In a case in which a plurality of the communication terminals 120 are included in the group list 101, a plurality of responsible parties who possess the communication terminals 120 can be notified of the state.

The responsible party who hears the voice data inputs a voice instruction including operation content for the machine 71 to the communication terminal 120 in response to the voice data. The communication terminal 120 transmits the voice data input from the responsible party to the communication server 100. In one example, the communication terminal 120 transmits a packet including the voice data to the communication server 100.

The communication server 100 converts the voice data received from the communication terminal 120 into text data, and stores the text data in the communication history 102 as a history log of the communication group. The communication history 102 includes a history log for each piece of communication between the communication terminal 120 in the communication group and the information processing device 20. The communication history 102 stores the history log of communication as text data. Accordingly, in the communication history 102, it is possible to search for a history log using a character string as a search word.

The response by the responsible party to the notification by the voice data may be performed by text input (email, chat, or the like) to the communication terminal 120. The communication terminal 120 transmits the text data including the operation content input by the operation of the responsible party to the communication server 100. The communication server 100 stores the received text data in the communication history 102.

Note that the notification data may be transmitted to the communication terminal 120 as text data. In this case, the notification data is transmitted from the communication server 100 to the communication terminal 120 by email, chat, or the like. In this case, the responsible party may transmit the operation content to the communication server 100 as text data by email, chat, or the like, or may transmit the operation content to the communication server 100 as voice data by a call. Even in these cases, the communication server 100 stores the received text data or the text data obtained by conversion of the received voice data in the communication history 102 in the same manner as described above.

The reception unit 22 of the information processing device 20 is configured to be able to communicate with the communication server 100. The reception unit 22 acquires response data based on the communication history 102 of the communication server 100. For example, the reception unit 22 is configured to search the communication history 102. The reception unit 22 searches the communication history 102 of the communication server 100 by using search words. Then, the reception unit 22 acquires a history log including the search words as response data.

The control unit 23 of the information processing device 20 is configured to be able to communicate with the control device 91 of the equipment 61. The control unit 23 outputs a control instruction for the machine 71 of the equipment 61 in accordance with the response data acquired by the reception unit 22. The control instruction includes the operation content of the machine 71 serving as the operation target. The operation content includes, for example, stopping the machine 71. Accordingly, the responsible party who possesses the communication terminal 120 can perform control such as stopping the machine 71 of the equipment 61 by inputting a voice instruction including the operation content to the communication terminal 120.

Depending on the timing at which the reception unit 22 acquires the response data, a plurality of the communication history logs including the search words may exist in the communication history 102. This occurs in a case in which a plurality of the communication terminals 120 are included in the group list 101 and voice data is transmitted to the plurality of communication terminals 120, resulting in responses from a plurality of responsible parties. In this case, the information processing device 20 is configured to acquire, as the response data, one of the plurality of communication history logs. For example, the information processing device 20 acquires, as the response data, a communication history log having the earliest registration time among the plurality of communication history logs. Note that the information processing device 20 may acquire, as the response data, a communication history log having the latest registration time. Further, in a case in which a password is set for each responsible party, the information processing device 20 may acquire one communication history log as the response data in accordance with the password included in the communication history log.

### Configuration of Information Processing Device

The information processing device 20 may be configured as a programmable logic controller (PLC) or a computer system.

FIG. 2 is a block diagram illustrating an example of a configuration of the information processing device 20, and illustrates an example of a computer system.

The information processing device 20 includes at least one processor 31, the storage unit 24, a communication unit 32, an input/output unit 33, and a connection unit 34. The processor 31 functions as the transmission unit 21, the reception unit 22, and the control unit 23 of the information processing device 20 illustrated in FIG. 1 by executing a control program stored in the storage unit 24. The processor 31 may be, for example, a central processing unit (CPU). The processor 31 may include main storage devices such as a random access memory (RAM) and a read only memory (ROM). The storage unit 24 may include a nonvolatile storage device such as a hard disk drive (HDD) or a solid state drive (SSD). The communication unit 32 is connected to the communication server 100 illustrated in FIG. 1. The input/output unit 33 is connected to the sensors 81, 82A, 82B, and 83, and the control devices 91, 92, and 93 illustrated in FIG. 1. The connection unit 34 is connected to a terminal 35. The terminal 35 is a setting terminal for setting various settings of the information processing device 20, and registered words and scenarios used as the search words described above. The terminal 35 may be a device configured exclusively for the information processing device 20, or a notebook computer, a tablet, or the like in which an application for settings is installed.

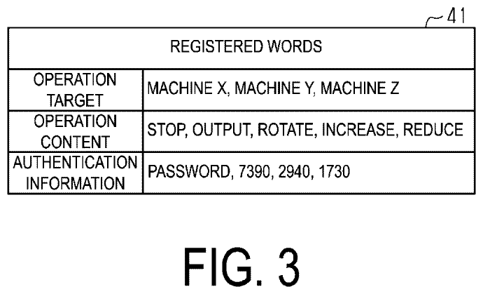

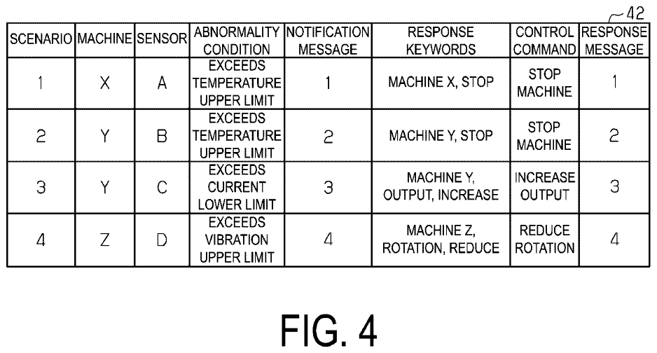

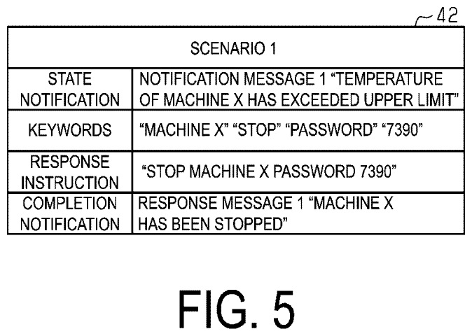

The storage unit 24 of the information processing device 20 stores registered words 41 illustrated in FIG. 3 or the scenarios illustrated in FIGS. 4 and 5. The information processing device 20 acquires response data according to the registered words 41 illustrated in FIG. 3 or the scenario 42 illustrated in FIGS. 4 and 5.

### Registered Words

FIG. 3 illustrates an example of the registered words 41 set in the information processing device 20. The registered words 41 are used for searching the communication history 102 by the reception unit 22 illustrated in FIG. 1. The registered words may include operation targets, operation content, and authentication information. The operation targets include character strings “machine X”, “machine Y”, and “machine Z” indicating the operation targets in the pieces of equipment 61, 62, and 63, that is, the machines 71, 72, and 73, illustrated in FIG. 1. The operation content is the content of operations of the machines 71, 72, and 73, and includes, for example, “stop”, “output”, “rotation”, “increase”, and “reduce”. The authentication information is data for authenticating the response data to be acquired, and includes, for example, the character strings “password”, “7390”, “2490”, and “1730”. The character string “password” is used to indicate that the subsequent character string is an actual password. “7930”, “2490”, and “1730” are passwords for authentication set for each operation target, for example. The password may be set for each operation content or may be set for each responsible party.

The information processing device 20 sets the keywords registered in the registered words 41 as search words, and searches the communication history 102 of the communication server 100. Thus, the information processing device 20 can acquire, from the communication history 102, the response data corresponding to the pieces of equipment 61, 62, and 63 connected to the information processing device 20 by using the registered words 41. The information processing device 20 can suppress acquisition of erroneous response data by using the registered words 41.

The registered words 41 include the password as approval information. Accordingly, the information processing device 20 can reliably acquire response data from the responsible party. Further, the information processing device 20 acquires response data including the password included in the search words. Accordingly, after the response data including the operation target and the operation content is acquired, it is not necessary to provide a processing step of confirming whether the response data is from the correct responsible party or the like.

### Scenarios

The scenarios set in the information processing device 20 will now be described with reference to FIGS. 4 to 7.

FIG. 4 illustrates an outline of the scenarios stored in the storage unit 24 of the information processing device 20. FIG. 5 illustrates an example of a scenario “1”.

The storage unit 24 of the information processing device 20 stores the scenarios. A scenario is a list indicating an order of processing executed by the information processing device 20.

A scenario is set for each of the machines 71, 72, and 73 in accordance with a state in which corresponding control is required. In one example, the scenarios are set in accordance with combinations of the machines 71, 72, and 73 and the sensors 81, 82A, 82B, and 83 provided in the machines 71, 72, and 73. In the information processing system 10 illustrated in FIG. 1, a scenario “1” corresponding to the machine 71 and the sensor 81 of the equipment 61, a scenario “2” corresponding to the machine 72 and the sensor 82A of the equipment 62, a scenario “3” corresponding to the machine 72 and the sensor 82B of the equipment 62, and a scenario “4” corresponding to the machine 73 and the sensor 83 of the equipment 63 are set.

Here, the scenario “1” will be described.

The scenario “1” indicates processing corresponding to a case in which a temperature abnormality of the machine 71 occurs in the machine 71 of the equipment 61. The information processing device 20 is configured to execute the processing according to the scenario “1”.

The information processing device 20 determines whether the sensor information by the sensor 81 corresponds to an abnormality condition of the machine 71. The abnormality condition is a condition for determining whether an abnormality has occurred in the machine 71 that is the operation target. For the machine 71, in a case in which the temperature of the machine 71 exceeds an upper limit on the basis of the sensor information by the sensor 81, the information processing device 20 determines that an abnormality occurred in the machine 71. Then, the information processing device 20 transmits notification data corresponding to the sensor information to the communication server 100 in FIG. 1.

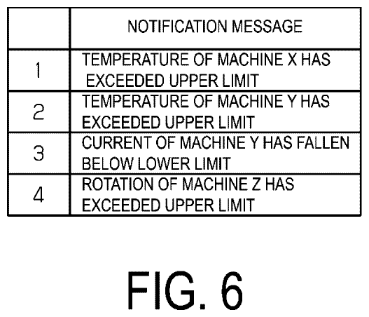

FIG. 6 illustrates notification messages in respective scenarios. The notification messages illustrated in FIG. 6 correspond to the sensor information by the sensors 81, 82A, 82B, and 83 illustrated in FIG. 1. For example, the notification message of the scenario “1” corresponds to the temperature of the machine 71 detected by the sensor 81 of the equipment 61. In one example, the notification message “1” is “The temperature of machine X has exceeded the upper limit”. In a case in which the temperature of the machine 71 exceeds the upper limit value on the basis of the sensor information by the sensor 81, the information processing device 20 illustrated in FIG. 1 transmits the notification data including the notification message “1” to the communication server 100. The communication server 100 converts the notification data into voice data and transmits the voice data to the communication terminal 120 set in the group list 101.

Response keywords for acquiring response data are set in the scenario “1”. The information processing device 20 sets the response keywords as the search words and searches the communication history 102 of the communication server 100 illustrated in FIG. 1. By this search, the information processing device 20 acquires a response instruction “stop machine X password 7390” stored in the communication history. With the search words including the character strings “password” and the password “7390”, the response instruction can be authenticated. Then, the information processing device 20 outputs a control instruction corresponding to the response data to the control device 91 of the equipment 61. The control instruction is for performing “stop machine” as illustrated in FIG. 4. The control device 91 of the equipment 61 stops the machine 71 according to the control instruction.

The information processing device 20 transmits the notification data including a response message of the scenario “1” to the communication server 100. The communication server 100 converts the notification data into voice data, and transmits the voice data to the communication terminals 120 set in the communication group of the group list 101. The communication terminal 120, by an operation by the responsible party, reproduces the voice data, that is, reproduces the response message.

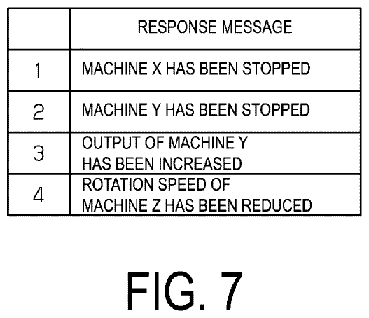

FIG. 7 illustrates the response messages in respective scenarios. The response messages illustrated in FIG. 7 are messages indicating that the controls of the control devices 91, 92, and 93 for the machines 71, 72, and 73, respectively, illustrated in FIG. 1 have been successfully completed. For example, the response message of the scenario “1” indicates that the machine 71 has been stopped. In one example, the response message “1” is “Machine X has been stopped”. Accordingly, the notification data including the response message may be regarded as completion data indicating that the operation content for the operation target has been successfully completed.

As illustrated in FIG. 4, the scenarios “2”, “3”, and “4” are stored in the storage unit 24 of the information processing device 20. The information processing device 20 transmits, according to the scenario “2”, the notification data including the notification message “2” to the communication server 100 on the basis of the sensor information by the sensor 82A of the equipment 62. Further, the information processing device 20 transmits, according to the scenario “3”, the notification data including the notification message “3” to the communication server 100 on the basis of the sensor information by the sensor 82B of the equipment 62. The information processing device 20 transmits, according to the scenario “4”, the notification data including the notification message “4” to the communication server 100 on the basis of the sensor information by the sensor 83 of the equipment 63.

The communication server 100 converts the notification data into voice data, and transmits a packet including the voice data to the communication terminals 120 set in the communication group of the group list 101. This makes it possible to notify the responsible party of states of abnormality that differ depending on the sensors 82A and 82B for the one machine 72.

Subsequently, the information processing device 20 searches the communication history 102 of the communication server 100 and acquires the response data. Then, the information processing device 20 outputs a control instruction to the control device 91 of the equipment 61. In this case, the response data obtained by the search using the response keywords of the scenario “2” as the search words indicates that the machine 72 is to be stopped. On the other hand, the response data obtained by the search using the response keywords of the scenario “3” as the search words indicates that the output of the machine 72 is to be increased. By thus setting the scenarios, it is possible to control the machine 72, which is one operation target, differently for each scenario.

### Processing Flow of Information Processing Device

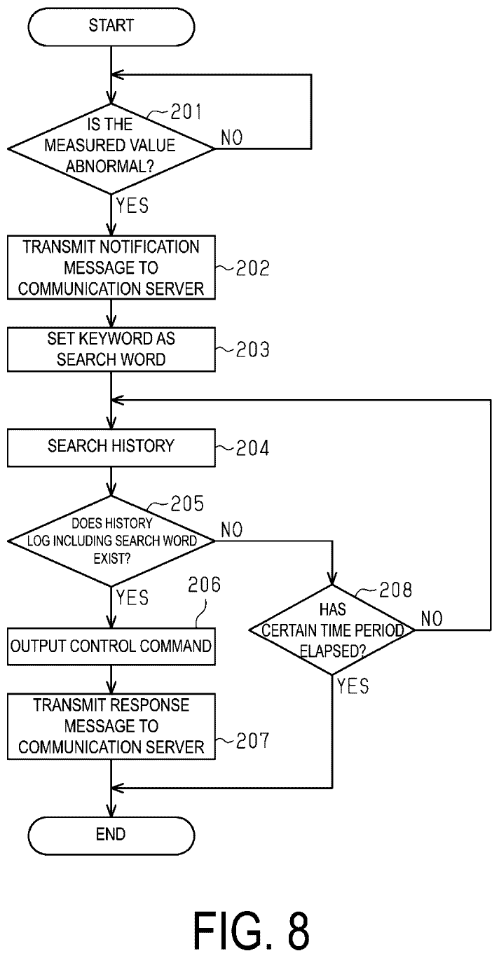

FIG. 8 is a flowchart illustrating the processing of the information processing device 20.

The scenarios illustrated in FIGS. 4 and 5 are obtained by setting the processing of the flowchart illustrated in FIG. 8.

As an example of the processing of the information processing device 20, the processing corresponding to the equipment 61 (machine 71, sensor 81, and control device 91) illustrated in FIG. 1 will be described.

The information processing device 20 executes the processing of the flowchart illustrated in FIG. 8.

As illustrated in FIG. 8, in step 201, the information processing device 20 determines whether the measured value of the sensor information by the sensor 81 of the equipment 61 is abnormal. The abnormality condition illustrated in FIG. 4 is used for this determination. In this case, the information processing device 20 determines that the measured value is not abnormal in a case in which the measured value is equal to or less than a temperature upper limit, and determines that the measured value is abnormal in a case in which the measured value exceeds the temperature upper limit. The information processing device 20 returns to step 201 in a case in which the measured value is not abnormal (determination: NO), and proceeds to step 202 in a case in which the measured value is abnormal (determination: YES). Note that, in a case in which the measured value is not abnormal (determination: NO), the processing may return to step 201 after waiting until a predetermined time period elapses.

In step 202, the information processing device 20 (transmission unit 21) transmits the notification message to the communication server 100, and proceeds to step 203.

In step 203, the information processing device 20 (reception unit 22) sets keywords as the search words, and proceeds to step 204.

Next, in step 204, the information processing device 20 (reception unit 22) conducts a history search using the search words. That is, the information processing device 20 searches the communication history 102 of the communication server 100 by using the search words.

Next, in step 205, the information processing device 20 determines whether a history log including the search words exists in the communication history 102. The information processing device 20 proceeds to step 206 in a case in which the history log exists (determination: YES), and proceeds to step 208 in a case in which the history log does not exist (determination: NO).

In step 206, the information processing device 20 (control unit 23) outputs a control instruction.

Next, in step 207, the information processing device 20 (transmission unit 21) transmits a response message to the communication server 100. Then, the information processing device 20 ends the processing related to the sensor information of the sensor 81 that has been determined to be abnormal in step 201.

In a case of proceeding from step 205 to step 208, the information processing device 20 determines whether a certain time period has elapsed. In a case in which the determination is made that the certain time period has not elapsed (determination: NO), the information processing device 20 proceeds from step 208 to step 204. That is, the information processing device 20 searches the communication history 102 of the communication server 100 until the predetermined time period elapses. Accordingly, the information processing device 20 (reception unit 22) can reliably acquire the response data of the response instruction from the responsible party. On the other hand, in a case in which the determination is made in step 208 that the certain time period has elapsed (determination: YES), the information processing device 20 ends the processing related to the sensor information of the sensor 81 that has been determined to be abnormal in step 201. That is, the information processing device 20, in a case of failure to acquire the response data by the elapse of the predetermined time period, stops searching the communication history. The stopping of the search in this manner leads to a reduction in load on the communication server 100. That is, the stopping makes it possible to reduce the load on the communication server 100. The certain time period determined in step 208 may be, for example, a time period after the notification message is transmitted to the communication server 100 in step 202. The certain time period is a first time period set for the information processing device 20. The first time period may be the same or may be different for each of the pieces of equipment 61, 62, and 63.

The responsible party identifies the abnormality of the machine 71 on the basis of the voice of the communication terminal 120. In a case in which the responsible party is near the equipment 61, the responsible party can stop the machine 71 by directly operating the machine 71 or by operating the control device 91. In this case, the responsible party may not provide a response instruction to the communication terminal 120. As a result, with the responsible party not providing a response instruction, response data is not stored in the communication history 102 of the communication server 100. That is, a history log including the search words is not stored. In a case in which step 208 is not included, the information processing device 20 repeatedly executes the processing of steps 204 and 205, and cannot end the processing related to the sensor information of the sensor 81 that the information processing device 20 has determined to be abnormal in step 201. Further, the processing for the other pieces of equipment 62 and 63 may be affected. Therefore, by including step 208, it is possible to end the processing or eliminate the impact on the processing on the other equipment 62 and 63. Note that, even if the responsible party who directly stops the machine 71 provides a response instruction to the communication terminal 120, the control device 91 controls the stopping of the stopped machine 71, and thus no inconvenience occurs.

### Operational Effects of First Embodiment

Hereinafter, operational effects of the first embodiment will be described.
(1-1) The information processing device 20 is connected to the pieces of equipment 61, 62, and 63 and is connected to the communication server 100 that communicates with the communication terminal 120 so as to enable data transmission and reception therewith. The pieces of equipment 61, 62, and 63 include the machines 71, 72, and 73 as operation targets, the sensors 81, 82A, 82B, and 83 provided in the machines 71, 72, and 73, and the control devices 91, 92, and 93 that operate the machines 71, 72, and 73. The information processing device 20 includes the transmission unit 21 that transmits, to the communication server 100, notification data for providing notification of information related to the machines 71, 72, and 73 on the basis of sensor information by the sensors 81, 82A, 82B, and 83, the reception unit 22 that acquires, from the communication server 100, response data in response to the notification data, and the control unit 23 that outputs, to the control devices 91, 92, and 93, a control instruction including operation content of the machines 71, 72, and 73 in accordance with the response data.

The communication server 100 transmits the notification data to the communication terminal 120. The communication terminal 120 is carried by the responsible party. The responsible party obtains information related to the machines 71, 72, and 73 from the notification data received by the communication terminal 120. Accordingly, even when the responsible party is away from the pieces of equipment 61, 62, and 63, the responsible party can easily identify the information related to the machines 71, 72, and 73 of the pieces of equipment 61, 62, and 63, respectively.

Then, the responsible party inputs the operation content for the identified machines 71, 72, and 73 to the communication terminal 120. The operation content is transmitted to the communication server 100 as the response data. The reception unit 22 of the information processing device 20 acquires the response data from the communication server 100. Then, the control unit 23 of the information processing device 20 outputs control instructions including the operation content of the machines 71, 72, and 73 to the control devices 91, 92, and 93 of the pieces of equipment 61, 62, and 63, respectively, in accordance with the response data. Accordingly, even if the responsible party is away from the pieces of equipment 61, 62, and 63, the machines 71, 72, and 73 of the pieces of equipment 61, 62, and 63, respectively, can be easily controlled.
(1-2) The communication server 100 includes the group list 101 in which the communication group including at least one communication terminal 120 is set and the communication history 102 of the communication group, and is configured to transmit the notification data to the communication group in the group list 101. The reception unit 22 acquires the response data based on the communication history 102 of the communication server 100. This makes it possible to readily notify the responsible party who possesses the communication terminal of the states of the machines 71, 72, and 73. Then, the response data from the responsible party can be readily acquired from the communication history 102 of the communication group.
(1-3) The reception unit 22 acquires the response data based on the communication history 102 by performing the search on the communication history 102. The reception unit 22 stops the search on the communication history 102 in a case in which the first time period elapses following the start of the search on the communication history 102. Accordingly, even in a case in which the response data cannot be acquired, the processing can be ended. Then, this makes it possible to reduce the load on the communication server 100.
(1-4) The reception unit 22 repeatedly performs the search on the communication history 102. Accordingly, it is possible to more reliably acquire the response data from the communication history 102.
(1-5) The control device 91 of the equipment 61 is configured to output a control result obtained by executing the control instruction on the machine 71. The control unit 23 acquires the control result, and the transmission unit 21 outputs notification data (completion data) including a completion notification corresponding to the control result to the communication server 100. Accordingly, the responsible party can easily confirm the control result.
(1-6) The sensor information includes measured values obtained by detecting the states of the machines 71, 72, and 73. The response data controls the machines 71, 72, and 73 in accordance with the measured values. This makes it possible to readily provide notification of the states of the machines 71, 72, and 73 and perform control according to the states.
(1-7) The information processing device 20 includes the storage unit 24 that stores the scenario 42 indicating the order of processing set corresponding to the sensors 81, 82A, 82B, and 83 and the machines 71, 72, and 73. The scenario 42 includes data of the state notification corresponding to the sensor information, the keyword indicating the operation target and the operation content for the operation target, and control instructions for the control devices 91, 92, and 93. The transmission unit 21 transmits the notification data according to the scenario 42. The reception unit 22 acquires the response data according to the scenario 42. This makes it possible to readily acquire the response data of the response instructions to the pieces of equipment 61, 62, and 63.
(1-8) The scenario 42 includes the abnormality condition with respect to the sensor information. The transmission unit 21 transmits the notification data in a case in which the measured value of the sensor information is abnormal on the basis of the sensor information and the abnormality condition. This makes it possible to readily notify the responsible party of the abnormalities of the machines 71, 72, and 73 of the pieces of equipment 61, 62, and 63, respectively, and easily control the machines 71, 72, and 73 of the pieces of equipment 61, 62, and 63, respectively.
(1-9) The plurality of pieces of equipment 61, 62, and 63 are connected to the information processing device 20. The scenario 42 is provided for each combination of the machines 71, 72, and 73 and the sensors 81, 82A, 82B, and 83 in the plurality of pieces of equipment 61, 62, and 63. This makes it possible to perform processing corresponding to each of the machines 71, 72, and 73 serving as the operation targets. Further, in the equipment 62 in which the two sensors 82A and 82B are provided for the one machine 72, it is possible to perform control corresponding to each state of the machine 72 according to the sensor information by the sensors 82A and 82B.
(1-10) The information processing device 20 includes the storage unit 24 that stores the registered words 41 corresponding to the pieces of equipment 61, 62, and 63. The registered words 41 include the keyword indicating the operation target and the keyword indicating the operation content for the operation target. The reception unit 22 sets the keywords of the registered words 41 as search words, searches the communication history 102, and acquires the response data including the search words. This makes it possible to readily acquire the response data of the response instructions to the pieces of equipment 61, 62, and 63.
(1-11) The registered words 41 include the authentication information. Accordingly, it is possible to authenticate the response instruction of the response data. This makes it possible to prevent acquisition of erroneous response data.
(1-12) The plurality of pieces of equipment 61, 62, and 63 are connected to the information processing device 20. In the registered words 41, the machines 71, 72, and 73 that are the operation targets of the plurality of pieces of equipment 61, 62, and 63 are registered. Accordingly, it is possible to easily operate the plurality of pieces of equipment 61, 62, and 63.

### Modification Example

The above-described embodiment can be modified and implemented as follows. The above-described embodiment and the following modification example can be implemented in combination with each other within a range where no technical contradiction occurs. In the following modification example, the same reference signs as those in the above-described embodiment are given to the same components as those in the above-described embodiment, and the description thereof will be omitted.

In the information processing system 10 illustrated in FIG. 1, the information processing device 20 may acquire the sensor information by the sensors 81, 82A, 82B, and 83 through the control devices 91, 92, and 93 of the pieces of equipment 61, 62, and 63. That is, the control device 91 of the equipment 61 may be configured to transmit the sensor information by the sensor 81 to the information processing device 20. Similarly, the control device 92 of the equipment 62 may be configured to transmit the sensor information by the sensors 82A and 82B to the information processing device 20. Further, the control device 93 of the equipment 63 may be configured to transmit the sensor information by the sensor 83 to the information processing device 20.

The processing in the information processing device 20 may be changed as desired.

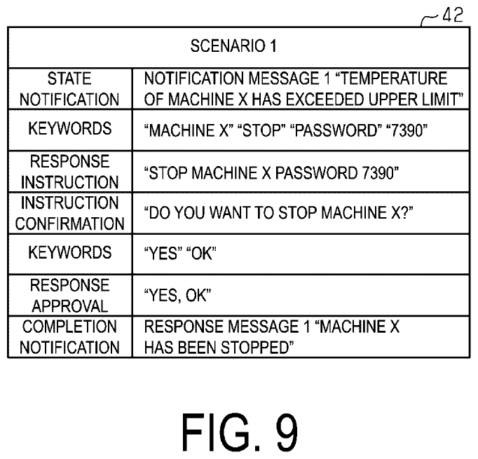

FIG. 9 illustrates a scenario “1” of the modification example.

The scenario “1” of the modification example includes instruction confirmation, keywords, and response approval. The instruction confirmation is for confirming the control content in response to the response instruction, and the information processing device 20 outputs the instruction confirmation as notification data to the communication server 100 in response to the response instruction. The instruction confirmation can be regarded as acceptance data indicating acceptance, which provides notification of acquisition of the response data including the response instruction. The keywords are keywords for searching the communication history 102 of the communication server 100 after transmission of the notification data of the instruction confirmation to the communication server 100. The information processing device 20 sets the keywords as search words and searches the communication history 102 of the communication server 100. The response approval indicates response data stored in the communication history 102 as a response instruction in response to the instruction confirmation. Upon acquisition of the response approval including the search words, the information processing device 20 outputs a control instruction to the control device 91 of the equipment 61. Thus, by transmitting the notification data of the instruction confirmation and acquiring the response data of the response approval, it is possible to make control of the machine 71 of the equipment 61 reliable.

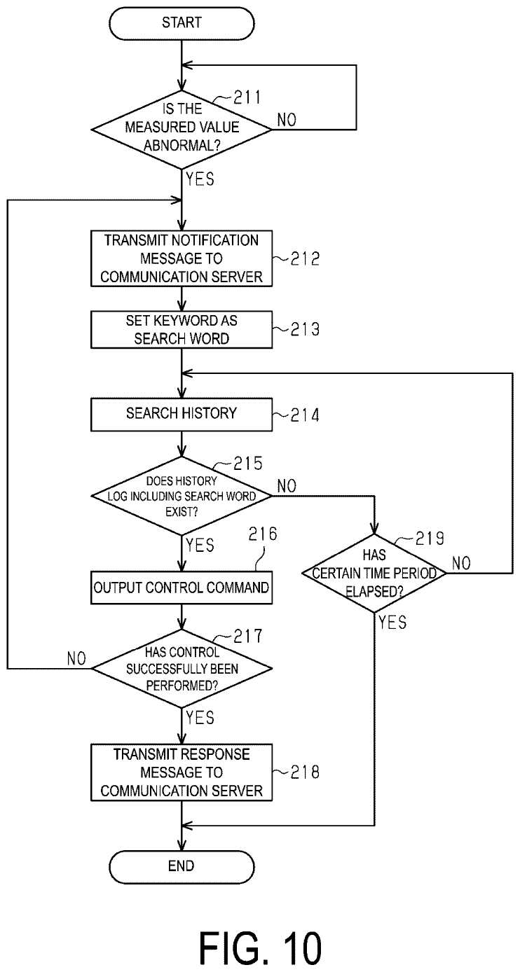

FIG. 10 illustrates a processing flowchart of the modification example.

In the flowchart illustrated in FIG. 10, steps 211 to 216, 218, and 219 are similar to steps 201 to 206, 207, and 208 in FIG. 8. That is, step 217 is added. In step 217, the information processing device 20 determines whether the control has been successfully performed. The result of the control may be output from the control device 91 of the equipment 61 to the information processing device 20, or may be a response to an inquiry from the information processing device 20 to the control device 91. In a case in which the control has been successfully performed (determination: YES), the information processing device 20 proceeds to step 218, transmits the notification data of the response message to the communication server 100, and ends the processing.

On the other hand, in a case in which the control has not been successfully performed in step 217 (determination: NO), the information processing device 20 proceeds to step 212 and transmits the notification data of the notification message to the communication server 100. This makes it possible to more reliably control the machine 71 of the equipment 61.

### Second Embodiment

Hereinafter, an information processing system 310 of a second embodiment will be described.

Note that, in the second embodiment, the same constituent elements as those of the first embodiment are denoted by the same reference signs, and part of the description thereof may be omitted.

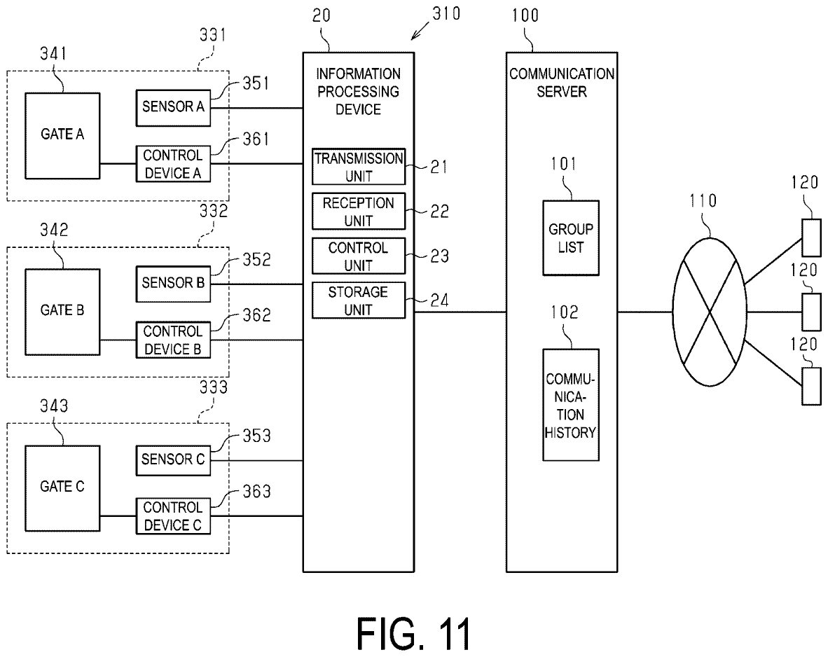

As illustrated in FIG. 11, the information processing device 20 of the information processing system 310 is connected to a plurality of pieces of equipment 331, 332, and 333. The information processing system 310 may be configured to include at least one piece of equipment.

The equipment 331 includes a gate 341 as an operation target, a sensor 351 provided to the gate 341, and a control device 361 for operating the gate 341. The gate 341 is, in one example, a gate provided in a facility such as a factory. The gate 341 includes a gate for entering the premises of the facility, a door for entering a building of the facility, or the like. In one example, the sensor 351 may be a sensor for detecting an operation request for the gate 341 as an operation target. The operation request is a request for unlocking or opening/closing the gate 341, and the sensor 351 is, for example, a call button. The sensor 351 is configured to output an operation request for the gate 341 as sensor information in response to operation of the sensor 351. The sensor 351 may be an operation button for performing an operation on the gate 341, a sensor that detects the operation, or the like. A contact sensor or a non-contact sensor can be used as the sensor that detects the operation. A control device 361 controls a driving unit such as a motor provided for unlocking a key provided in the gate 341 and opening/closing the gate 341. The pieces of equipment 332 and 333 include gates 342 and 343, sensors 352 and 353, and control devices 362 and 363, respectively, similar to the equipment 331.

FIG. 11 indicates names for distinguishing the gates 341, 342, and 343, the sensors 351, 352, and 353, and the control devices 361, 362, and 363 of the pieces of equipment 331, 332, 333, respectively, by the information processing device 20. In the example illustrated in FIG. 11, the gates 341, 342, and 343 are indicated as “gate A”, “gate B”, “gate C”, respectively. In the information processing device 20, the character strings indicated in FIG. 11 are registered, and the gates 341, 342, and 343 are handled in a distinguishable manner. Further, in FIG. 11, the sensors 351, 352, and 353 are indicated as “sensor A”, “sensor B”, and “sensor C”, respectively, and the control devices 361, 362, and 363 are indicated as “control device A”, “control device B”, “control device C”, respectively. In the information processing device 20, the character strings illustrated in FIG. 11 are registered and the sensors 351, 352, and 353 and the control devices 361, 362, and 363 are handled in a distinguishable manner.

The information processing device 20 is connected to the pieces of equipment 331, 332, and 333. Specifically, the information processing device 20 is connected so as to enable acquisition of the sensor information of the sensors 351, 352, and 353 of the pieces of equipment 331, 332, and 333, respectively. The information processing device 20 is connected to the control devices 361, 362, and 363 of the pieces of equipment 331, 332, and 333, respectively so as to enable data transmission and reception.

In FIG. 11, the information processing device 20 is individually connected to the pieces of equipment 331, 332, and 333. The information processing device 20 and the pieces of equipment 331, 332, and 333 may be connected by a network such as a local area network directly or indirectly using a gateway or the like. Further, the information processing device 20 and the pieces of equipment 331, 332, and 333 may be connected by a wired communication path or a wireless communication path.

### Overview of Processing of Information Processing Device 20

The information processing device 20 has a function of notifying each communication terminal 120 of states of the operations, such as a call, at the gates 341, 342, and 343 of the pieces of equipment 331, 332, and 333 through the communication server 100. Accordingly, the responsible party who carries the communication terminal 120 can easily identify the states of the pieces of equipment 331, 332, and 333, such as the fact that a call has been made, by the notification from the information processing device 20 through the communication server 100.

The information processing device 20 has a function of acquiring information for control from each communication terminal 120 through the communication server 100. The information processing device 20 has a function of outputting control instructions for the gates 341, 342, and 343 of the pieces of equipment 331, 332, and 333, respectively, to the control devices 361, 362, and 363 of the pieces of equipment 331, 332, and 333, respectively, on the basis of the acquired information for control. The control devices 361, 362, and 363 have a function of controlling the gates 341, 342, and 343, respectively, on the basis of the control instructions. Accordingly, even in a case that the responsible party holding the communication terminal 120 is located at a position away from the pieces of equipment 331, 332, and 333, the responsible party can control the gates 341, 342, and 343 of the pieces of equipment 331, 332, and 333, respectively, at that position.

The processing functions of the information processing device 20 will now be described with reference to FIG. 11.

The information processing device 20 includes the transmission unit 21, the reception unit 22, the control unit 23, and the storage unit 24.

The processing functions of the information processing device 20 are similar for each piece of equipment 331, 332, and 333. Therefore, in the following, the processing for the equipment 331 will be mainly described, and the pieces of equipment 332 and 333 will be referenced, as necessary.

The transmission unit 21 transmits, to the communication server 100, notification data for providing notification of an operation, for example, a call, on the gate 341 as an operation target on the basis of the sensor information from the sensor 351. The communication server 100 transmits the notification data to the communication terminals 120 of the communication group. In one example, the communication server 100 converts the notification data into voice data. Then, the communication server 100 transmits the voice data to the communication terminals 120 of the communication group. In one example, the communication server 100 transmits a packet including the voice data to the communication terminals 120 of the communication group. That is, the communication server 100 performs one-to-many group simultaneous voice communication. The communication terminal 120 reproduces the voice data, that is, the notification message received by the communication terminals 120, according to the operation of the responsible party. Thus, the information processing device 20 can notify the responsible party who possesses the communication terminal 120 of the state of the gate 341 of the equipment 331 by using the communication server 100.

The responsible party who heard the voice data inputs a voice instruction including the operation content for the gate 341 to the communication terminal 120 in response to the voice data. The operation content is, for example, unlocking the gate 341. The communication terminal 120 transmits the voice data input from the responsible party to the communication server 100. In one example, the communication terminal 120 transmits a packet including the voice data to the communication server 100.

The communication server 100 converts the voice data received from the communication terminal 120 into text data, and stores the text data in the communication history 102 as a history log of the communication group. The communication history 102 includes a history log for each piece of communication between the communication terminal 120 in the communication group and the information processing device 20. The communication history 102 stores the history logs of communication as text data. Accordingly, in the communication history 102, it is possible to search for a history log using a character string as a search word.

The reception unit 22 of the information processing device 20 is configured to be able to communicate with the communication server 100. The reception unit 22 searches the communication history 102 of the communication server 100 by using search words. Then, the reception unit 22 acquires a history log including the search words as response data.

The control unit 23 of the information processing device 20 is configured to be able to communicate with the control device 361 of the equipment 331. The control unit 23 outputs a control instruction to the gate 341 of the equipment 331 in accordance with the response data acquired by the reception unit 22. The control instruction includes the operation content of the gate 341 as an operation target. The operation content includes, for example, unlocking the gate 341. Accordingly, the responsible party who possesses the communication terminal 120 can perform control such as unlocking the gate 341 of the equipment 331 by inputting a voice instruction including the operation content to the communication terminal 120.

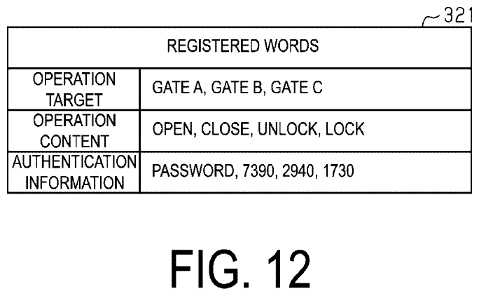

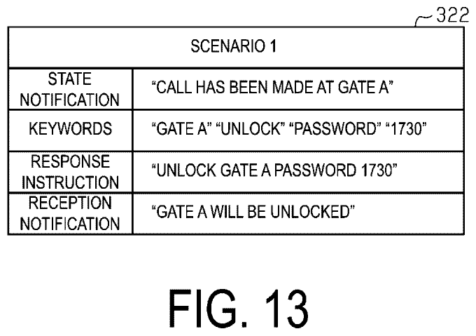

The storage unit 24 of the information processing device 20 stores registered words 321 illustrated in FIG. 12 or a scenario 322 illustrated in FIG. 13. The information processing device 20 acquires response data in accordance with the registered words 321 illustrated in FIG. 12 or the scenario 322 illustrated in FIG. 13.

### Registered Words

FIG. 12 illustrates an example of the registered words 321 set in the information processing device 20.

The registered words 321 are used for searching the communication history 102 by the reception unit 22 illustrated in FIG. 11. The registered words may include operation targets, operation content, and authentication information. The operation targets includes the operation targets of the pieces of equipment 331, 332, and 333 illustrated in FIG. 11, that is, the character strings “gate A”, “gate B”, and “gate C” indicating the gates 341, 342, and 343, respectively. The operation content is the content of operations of the gates 341, 342, and 343, and includes, for example, “open”, “close”, “unlock”, and “lock”. The authentication information is data for authenticating the response data to be acquired, and includes, for example, the character strings “password”, “7390”, “2490”, and “1730”. The character string “password” is used to indicate that the subsequent character string is an actual password. “7930”, “2490”, and “1730” are passwords for authentication set for each operation target, for example. The password may be set for each operation content or may be set for each responsible party.

The information processing device 20 sets the keywords registered in the registered words 321 as search words, and searches the communication history 102 of the communication server 100. Thus, the information processing device 20 can acquire, from the communication history 102, the response data corresponding to the pieces of equipment 331, 332, and 333 connected to the information processing device 20 by using the registered words 321. Further, the information processing device 20 can prevent acquisition of erroneous response data by using the registered words 321.

The registered words 321 includes the password as the approval information. Accordingly, the information processing device 20 can reliably acquire response data from the responsible party. Further, the information processing device 20 acquires response data including the password included in the search words. Accordingly, after the response data including the operation target and the operation content is acquired, it is not necessary to provide a processing step of confirming whether the response data is from the correct responsible party or the like.

### Scenarios

FIG. 13 illustrates an example of the scenario 322 set in the information processing device 20. Note that FIG. 13 illustrates the scenario 322 for the equipment 331 illustrated in FIG. 11.

The scenario “1” indicates processing corresponding to a case in which a call has been made for the gate 341 of the equipment 331. The information processing device 20 is configured to execute the processing according to the scenario “1”.

The information processing device 20 determines whether a call has been made for the gate 341 on the basis of the sensor information of the sensor 351. In a case in which a call has been made for the gate 341, the information processing device 20 transmits notification data of a state notification as a notification message to the communication server 100 in FIG. 11.

Response keywords for acquiring response data are set in the scenario “1”. The information processing device 20 sets the response keywords as the search words and searches the communication history 102 of the communication server 100 illustrated in FIG. 1. By this search, the information processing device 20 acquires the response instruction “unlock gate A password 1730” stored in the communication history. With the search words including the character strings “password” and the password “1730”, the response instruction can be authenticated. Then, the information processing device 20 outputs a control instruction corresponding to the response data to the control device 361 of the equipment 331. The control instruction is for performing “unlock gate” as illustrated in FIG. 4. The control device 361 of the equipment 331 unlocks the gate 341 in accordance with the control instruction.

The information processing device 20 transmits notification data including a reception notification of the scenario “1” as a response message to the communication server 100. The communication server 100 converts the notification data into voice data, and transmits the voice data to the communication terminals 120 set in the communication group of the group list 101. The communication terminal 120, by an operation by the responsible party, reproduces the voice data, that is, reproduces the reception notification.

### Processing Flow of Information Processing Device

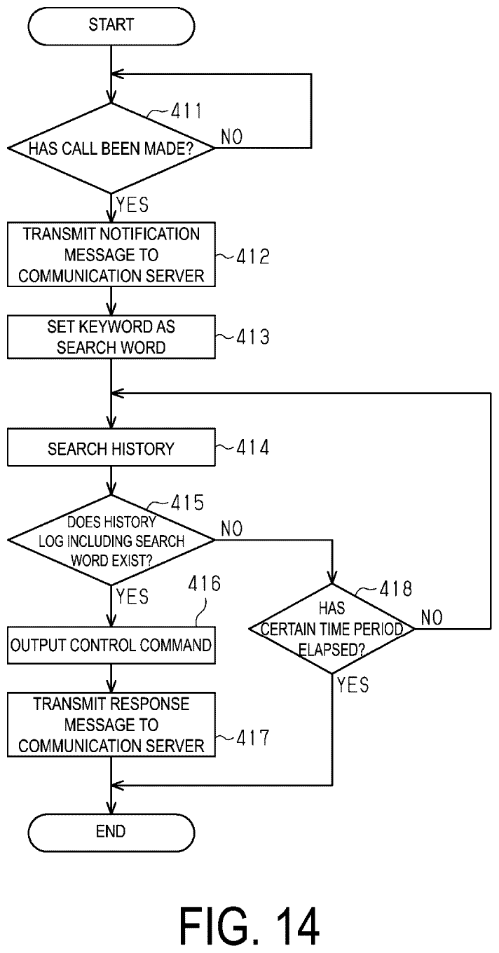

FIG. 14 is a flowchart illustrating the processing of the information processing device 20.

The scenario illustrated in FIG. 13 is a scenario in which the processing of the flowchart illustrated in FIG. 14 is set.

As an example of the processing of the information processing device 20, the processing corresponding to the equipment 331 (gate 341, sensor 351, and control device 361) illustrated in FIG. 11 will be described.

The information processing device 20 executes the processing of the flowchart illustrated in FIG. 14.

As illustrated in FIG. 14, in step 411, the information processing device 20 determines whether a call has been made for the gate 341 on the basis of the sensor information of the sensor 351 of the equipment 331. The information processing device 20 returns to step 411 in a case in which a call has not been made (determination: NO), and proceeds to step 412 in a case in which a call has been made (determination: YES). Note that, in a case in which a call has not been made (determination: NO), the processing may return to step 411 after waiting until a predetermined time period elapses.

In step 412, the information processing device 20 transmits a state notification as a notification message to the communication server 100, and proceeds to step 413.

In step 413, the information processing device 20 sets keywords to search words.

Next, in step 414, the information processing device 20 conducts a history search by the search words. That is, the information processing device 20 searches the communication history 102 of the communication server 100 by using the search words.

Next, in step 415, the information processing device 20 determines whether a history log including the search words exists in the communication history 102. The information processing device 20 proceeds to step 416 in a case in which a history log exists (determination: YES), or proceeds to step 418 in a case in which a history log does not exist (determination: NO).

In step 416, the information processing device 20 outputs a control instruction.

Next, in step 417, the information processing device 20 transmits notification data of the reception notification as a response message to the communication server 100. Then, the information processing device 20 ends the processing related to the sensor information of the sensor 351 that the information processing device 20 determined in step 411 to be the sensor for which the call has been made.

In a case in which the processing proceeds from step 415 to step 418, the information processing device 20 determines whether a certain time period elapsed. In a case in which the certain time period has not elapsed (determination: NO), the information processing device 20 proceeds from step 418 to step 414. That is, the information processing device 20 searches the communication history 102 of the communication server 100 until the certain time period elapses. On the other hand, in a case in which the certain time period elapsed (determination: YES), the information processing device 20 ends the processing related to the sensor information of the sensor 351 that the information processing device 20 determined in step 411 to be the sensor for which the call has been made. The elapsed time period in step 418 may be, for example, a time period from when the notification message is transmitted to communication server 100 in step 412. The certain time period is a first time period set for the information processing device 20. The first time period may be the same or may be different for each piece of equipment 331, 332, 333.

### Operational Effects of Second Embodiment

Hereinafter, operational effects of the second embodiment will be described.
(2-1) In the information processing system 310 of the second embodiment, the gates 341, 342, and 343 of the pieces of equipment 331, 332, and 333, respectively, can be easily controlled by the information processing device 20 connected to the pieces of equipment 331, 332, and 333 including the gates 341, 342, and 343, respectively, as the operation targets, as in the first embodiment.
(2-2) The sensor information indicates the operation request for the gates 341, 342, and 343 as the operation targets. The response data is used to control the gates 341, 342, and 343 in accordance with the operation request, and thus the gates 341, 342, and 343 as the operation targets for which the operation request is required can be easily controlled.

### Modification Example

The above-described embodiment can be modified and implemented as follows. The above-described embodiment and the following modification example can be implemented in combination with each other within a range where no technical contradiction occurs. In the following modification example, the same reference signs as those in the above-described embodiment are given to the same components as those in the above-described embodiment, and the description thereof will be omitted.

The information processing device 20 may be configured to start searching the communication history 102 after a second time period elapses following transmission of the notification data to the communication server 100. By waiting for the second time period before searching the communication server 100, the response data from the responsible party is more likely to be stored in the communication history 102 of the communication server 100. This makes it possible to quickly acquire the response data after the start of the search. Accordingly, a communication count from the information processing device 20 to the communication server 100 can be reduced. This leads to a reduction in the communication load between the information processing device 20 and the communication server 100 and a reduction in the load on the communication server 100.

The information processing device 20 may repeatedly execute the processing of the flowcharts illustrated in FIGS. 8, 10, and 14 at regular time intervals. In this case, for example, in the processing illustrated in FIG. 8, the processing may be ended in a case in which the determination is made in step 201 that an abnormality does not exist.

The information processing device 20 may start the processing of the flowcharts illustrated in FIGS. 8, 10, and 14 on the basis of the sensor information of the sensors. For example, the processing may be started by using operation of the sensor 351 illustrated in FIG. 11 as a trigger.

The embodiments disclosed herein are merely examples in all respects, and the present invention is not limited to these examples. That is, the scope of the present invention is defined by the claims, and is intended to include any modifications within the meaning and scope equivalent to the claims.

### REFERENCE SIGNS LIST

10: Information processing system, 20: Information processing device, 21: Transmission unit, 22: Reception unit, 23: Control unit, 24: Storage unit, 31: Processor, 32: Communication unit, 33: Input/output unit, 34: Connection unit, 35: Terminal, 41: Registered words, 42: Scenario, 61 to 63: Equipment, 71 to 73: Machine, 81, 82A, 82B, and 83: Sensor, 91 to 93: Control device, 100: Communication server, 101: Group list, 102: Communication history, 110: Communication path, 120: Communication terminal, 310: Information processing system, 321: Registered words, 322: Scenario, 331 to 333: Equipment, 341 to 343: Gate, 351 to 353: Sensor, 361 to 363: Control device.

1. An information processing device connected to equipment and connected to a communication server and configured to transmit and receive data with the communication server, wherein
the equipment includes an operation target, a sensor provided in the operation target, and a control device that operates the operation target, and
the information processing device includes:
a transmission unit that transmits, to the communication server, notification data for providing notification of information related to the operation target on the basis of sensor information by the sensor;
a reception unit that acquires, from the communication server, response data in response to the notification data; and
a control unit that outputs, to the control device, a control instruction including operation content of the operation target in accordance with the response data.

2. The information processing device according to claim 1, wherein
the communication server includes a group list in which a communication group including at least one communication terminal is set and a communication history of the communication group, and is configured to transmit the notification data to the communication group in the group list, and
the reception unit acquires the response data based on the communication history of the communication server.

3. The information processing device according to claim 2, wherein
the reception unit acquires the response data based on the communication history by performing a search on the communication history and stops the search on the communication history when a first time period elapses following a start of the search on the communication history.

4. The information processing device according to claim 3, wherein
the reception unit repeatedly performs a search on the communication history.

5. The information processing device according to claim 3, wherein
the reception unit starts a search on the communication history of the communication server after a second time period elapses following transmission of the notification data to the communication server by the transmission unit.

6. The information processing device according to claim 1, wherein
the control device of the equipment is configured to output a control result obtained by executing the control instruction on the operation target,
the control unit acquires the control result, and
the transmission unit outputs completion data corresponding to the control result to the communication server.

7. The information processing device according to claim 2, wherein
the information processing device includes a storage unit that stores a scenario indicating an order of processing set corresponding to the sensor and the operation target,
the scenario includes data of a state notification corresponding to the sensor information, a keyword indicating the operation target and the operation content for the operation target, and the control instruction for the control device,
the transmission unit transmits the notification data according to the scenario, and
the reception unit acquires the response data according to the scenario.

8. The information processing device according to claim 7, wherein
the scenario includes an abnormality condition with respect to the sensor information, and
the transmission unit transmits the notification data when a measured value of the sensor information is abnormal on the basis of the sensor information and the abnormality condition.

9. The information processing device according to claim 7, wherein
a plurality of pieces of the equipment are connected to the information processing device, and
the scenario is provided for a combination of the operation target and the sensor for each of the plurality of pieces of the equipment.

10. The information processing device according to claim 2, wherein
the information processing device includes a storage unit that stores registered words corresponding to the equipment,
the registered words include a keyword indicating the operation target and a keyword indicating the operation content for the operation target, and
the reception unit sets the keyword of the registered words as a search word, searches the communication history, and acquires the response data including the search word.

11. The information processing device according to claim 10, wherein
the registered words include authentication information.

12. The information processing device according to claim 10, wherein
a plurality of pieces of the equipment are connected to the information processing device, and
in the registered words, the operation target of each of the plurality of pieces of the equipment is registered.

13. An information processing method executed by an information processing device connected to equipment and connected to a communication server and configured to transmit and receive data with the communication server, wherein
the equipment includes an operation target, a sensor provided in the operation target, and a control device that operates the operation target, and
processing executed by the information processing device includes:
transmitting, to the communication server, notification data for providing notification of information related to the operation target on the basis of sensor information by the sensor;
acquiring, from the communication server, response data in response to the notification data; and
outputting, to the control device, a control instruction including operation content of the operation target in accordance with the response data.
